(19) United States
(12) Patent Application Publication
(10) Pub. No.: US 2009/0140049 A1
(43) Pub. Date: Jun. 4, 2009

(54) Stray light reduction in imaging reader

(76) Inventors: Rong Liu, Selden, NY (US); Ming Yu, South Setauket, NY (US)

Correspondence Address: KIRSCHSTEIN, ISRAEL, SCHIFFMILLER & PIERONI, P.C., 425 Fifth Avenue, 5TH FLOOR, New York, NY, 10016-2223, US

(21) Appl. No.: 11/998,554

(22) Filed: Nov. 30, 2007

(51) Int. Cl. G06K 7/10

(52) U.S. Cl. 235/462.41

(57) ABSTRACT

A solid-state imager and an optical lens in an imaging reader for electro-optically reading indicia are operative for capturing light from the indicia over a field of view during reading. A holder holds the optical lens. A baffle is integrated with the holder, for reducing the image-degrading effects of stray light directed to the imager.

### BACKGROUND OF THE INVENTION

Various electro-optical readers have previously been developed for reading both one- and two- dimensional bar code symbols appearing on a label or surface of a product or target. The symbol itself is a coded pattern of indicia. An example of a one-dimensional bar code symbol is a Universal Product Code (UPC) symbol. Examples of two-dimensional symbols are Code 49, as described in U.S. Pat. No. 4,794,239, and PDF417, as described in U.S. Pat. No. 5,304,786. Generally, the readers electro-optically transform graphic indicia of the symbols into electrical signals, which are decoded into alphanumeric characters. The resulting characters describe the target and/or some characteristic of the target with which the symbol is associated. Such characters typically comprise input data to a data processing system for applications in point-of-sale processing, inventory control, article tracking and the like.

A moving laser beam electro-optical reader has been disclosed for reading both one- and two-dimensional symbols, for example, in U.S. Pat. No. 4,251,798; U.S. Pat. No. 4,369,361; U.S. Pat. No. 4,387,297; U.S. Pat. No. 4,409,470; U.S. Pat. No. 4,760,248; and U.S. Pat. No. 4,896,026. Both one- and two-dimensional symbols can also be read by employing an imaging reader containing a solid-state imager that includes a one- or two-dimensional array of cells or photosensors that correspond to image elements or pixels in a field of view of the imager. In a workstation, hands-free mode of operation, an operator of the imaging reader slides or swipes a symbol across a window of the reader in a “swipe” mode, or merely presents the symbol to the window by holding the symbol momentarily steady in a “presentation” mode. In a portable handheld mode of operation, the operator may pick up the reader to scan large and/or heavy objects that cannot be easily positioned in front of the reader. The choice depends on operator preference or on the layout of the environment. The symbol must be located within a range of working distances relative to the window in order to be successfully read.

An optical assembly comprised of one or more lenses in the imaging reader captures either indoor or outdoor ambient light reflected or scattered from the symbol especially in the case of a brightly lit environment, as well as either internal or external illumination light directed at the symbol for reflection and scattering therefrom especially in the case of a dimly lit environment in response to actuation of a trigger. The captured light passes through the window to the imager, which may advantageously be a one- or two-dimensional charge coupled device (CCD) or a complementary metal oxide semiconductor (CMOS) device and includes associated circuits for producing electronic signals indicative of the captured light and corresponding to a one- or two-dimensional array of pixel information over the field of view. The electronic signals may be processed by a microprocessor either locally or sent to, and processed in, a remote host to read the symbol from the captured light.

As advantageous as such imaging readers are in capturing data as stand-alone or portable data capture systems, such a reader is usually very sensitive to stray or unwanted light from the above-described ambient and illumination light. Stray light often causes ghost images, as well as lowering the contrast of the image of the symbol being read. Such stray light degrades reader performance. In an effort to reduce stray light effects, it is known to anodize, or to apply a black coating on, holders for optical components in the readers. However, most black coatings are not completely light absorptive and, in many cases, exhibit wide variations in their diffuse and specular reflection characteristics.

### SUMMARY OF THE INVENTION

One feature of the present invention resides, briefly stated, in a reader for electro-optically reading indicia, such as one- or two-dimensional symbols, located in a range of working distances relative to the reader. The reader includes a housing having a window and could be operated in a workstation mode in which the reader rests directly on a support surface such as a countertop, or in a stand resting on the support surface, and is stationary during reading, and/or in a handheld mode in which the reader is held in an operator's hand during reading. During reading, in the case of the workstation mode, the symbol is swiped past, or presented to, the window and, in the case of the handheld mode, the reader itself is moved relative to, and aimed at, the symbol. In the preferred embodiment, the reader is used in a retail establishment.

An optical assembly is mounted in the housing for capturing light from the indicia through the window over the field of view during the reading. The optical assembly includes a one- or two-dimensional, solid-state imager having an array of image sensors, preferably a CCD or a CMOS array. The optical assembly further includes one or more optical elements, such as an imaging lens and an aperture stop, spaced away from the imager along an optical axis, and a holder for holding the imaging lens.

The imager is preferably associated with an illuminator for illuminating the indicia with illumination light to enable an image of the indicia to be acquired, preferably in a very short period of time, for example, on the order of 500 microseconds, so that the indicia image is not blurred even if there is relative motion between the imager and the indicia. The illumination light is preferably brighter in intensity than that of ambient illumination, especially close to the window. The illuminator preferably includes a single light source or light emitting diode (LED), but may include a plurality of light sources or LEDs, and a lightpipe constituted of an optical material and operative for optically guiding the illumination light from the light source(s) toward the indicia. The imager is operative for sensing the illumination light scattered or reflected from the indicia.

In accordance with this invention, a baffle is provided for reducing an amount of stray light directed to the imager. The stray or unwanted light arises from the above-described ambient and illumination light. The baffle effectively rejects any ambient and/or illumination light incident on the lens holder at an angle that would otherwise scatter and/or reflect towards the imager and create ghost images and low contrast images of the indicia being read. The baffle reduces the formation of such ghost images and low contrast images, thereby improving reader performance.

The baffle is advantageously integrated into the lens holder, thereby making for a compact design. A light-absorptive coating is applied on the baffle and the holder. The integral baffle reduces assembly and manufacturing costs and promotes the use of the reader as a miniature component or subsystem in a non-stand-alone apparatus, or a myriad of other apparatuses, such as a telephone, a mobile computer, or the like, where space is at a premium.

In a preferred construction, the holder is a generally cylindrical barrel having a diameter and opposite axial end regions, and the baffle is located at one of the end regions of the barrel. The baffle is advantageously annular and has a diameter greater than the diameter of the barrel. In one embodiment, the baffle has a plurality of surfaces for reflecting and scattering the stray light incident thereon away from the imager. One of the surfaces is inclined relative to the optical axis, and another of the surfaces is generally orthogonal to the optical axis. In another embodiment, the baffle has a plurality of stepped elements of different dimensions as considered in a direction generally orthogonal to the optical axis, and the different dimensions of the stepped elements increase in a direction along the optical axis toward the imager.

Another feature of the present invention resides, briefly stated, in a method of electro-optically reading indicia, the method being performed by capturing light from the indicia over a field of view during the reading with a solid-state imager having an array of image sensors, by spacing an optical lens away from the imager along an optical axis, by holding the optical lens with a holder, and by reducing an amount of stray light directed to the imager by integrating a baffle with the holder.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of one embodiment of a portable electro-optical reader operative in either a hand-held mode, or in the illustrated workstation mode, in accordance with this invention;

FIG. 2 is a perspective view of another embodiment of a portable electro-optical reader operative in either a hand-held mode, or in the illustrated workstation mode, in accordance with this invention;

FIG. 3 is a block circuit diagram of various components of the embodiment of FIG. 1 in the workstation mode;

FIG. 4 is a side view of one embodiment of a light baffling arrangement for use with the readers of FIGS. 1-2 in accordance with this invention; and

FIG. 5 is a side view of another embodiment of a light baffling arrangement for use with the readers of FIGS. 1-2 in accordance with this invention.

### DETAILED DESCRIPTION OF THE PREFERRED EMBODIMENTS

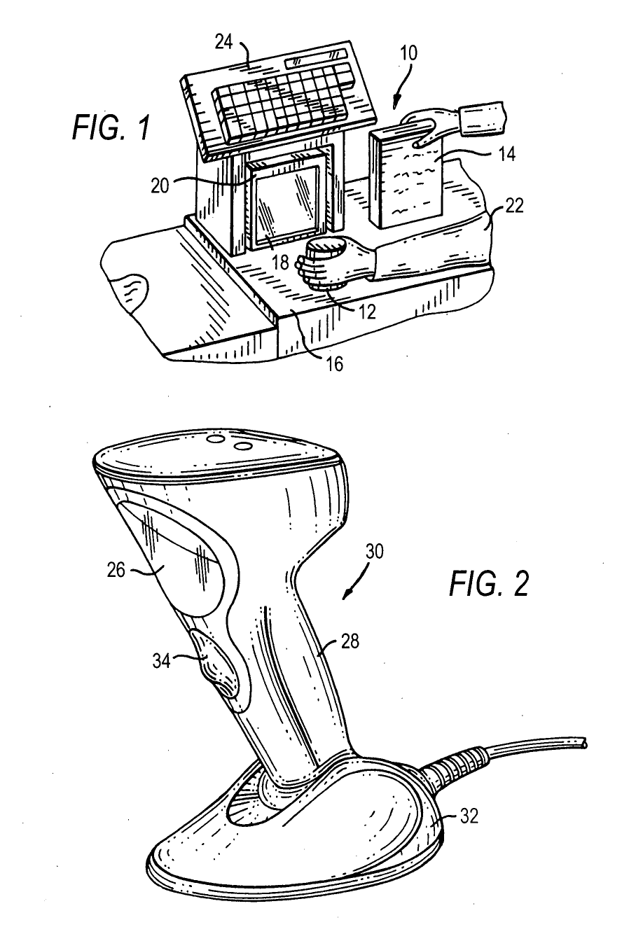

Reference numeral 10 in FIG. 1 generally identifies an electro-optical reader in a workstation mode for processing transactions and mounted on a checkout counter at a retail site at which products, such as a can 12 or a box 14, each bearing a target symbol, are processed for purchase. The counter includes a countertop 16 across which the products are slid at a swipe speed past a generally vertical window 18 of a box-shaped imaging reader 20 mounted on the countertop 16. A checkout clerk or operator 22 is located at one side of the countertop, and the reader 20 is located at the opposite side. A cash/credit register 24 is located within easy reach of the operator. The reader 20 is portable and lightweight and may be picked up from the countertop 16 by the operator 22, and the window 18 may be aimed at a symbol preferably on a product too heavy or too large to be easily positioned on the countertop in front of the reader in the workstation mode.

Reference numeral 30 in FIG. 2 generally identifies another portable, electro-optical imaging reader having a different configuration from that of reader 20. Reader 30 also has a generally vertical window 26 and a gun-shaped housing 28 supported by a base 32 for directly supporting the reader 30 on a countertop. The reader 30 can thus be used as a stationary workstation in which products are slid or swiped past the generally vertical window 26, or can be picked up off the countertop and held in the operator's hand and used as a handheld reader in which a trigger 34 is manually depressed to initiate reading of the symbol.

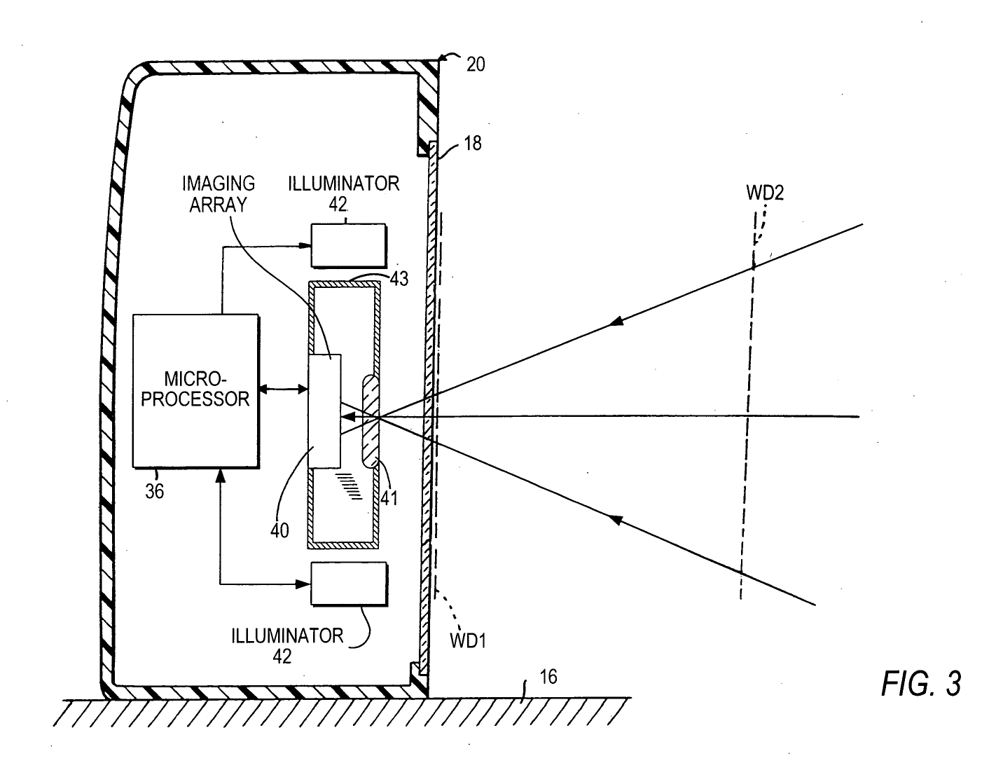

Each reader 20, 30 includes, as shown for representative reader 20 in FIG. 3, an optical assembly including an imager 40 and an imaging lens 41 that are mounted on a support or holder 43. The imager 40 is a solid-state device, for example, a CCD or a CMOS imager and has a linear or area array of addressable image sensors operative for capturing light through the window 18 from a target; for example, a one- or two-dimensional symbol, over a field of view and located in a working range of distances between a close-in working distance (WD1) and a far-out working distance (WD2). In a preferred embodiment, WD1 is about two inches from the imager array 40 and generally coincides with the window 18, and WD2 is about eight inches from the window 18. An illuminator 42 is also mounted in the reader and preferably includes a plurality of light sources, e.g., light emitting diodes (LEDs) 42, arranged around the imager 40 to uniformly illuminate the target symbol.

As shown in FIG. 3, the imager 40 and the illuminator 42 are operatively connected to a controller or microprocessor 36 operative for controlling the operation of these components. Preferably, the microprocessor is the same as the one used for decoding light scattered from the indicia and for processing the captured target symbol images.

In operation, the microprocessor 36 sends a command signal to the illuminator 42 to pulse the LEDs for a short time period of 500 microseconds or less, and energizes the imager 40 to collect light from a target symbol substantially only during said time period. A typical array needs about 33 milliseconds to read the entire target image and operates at a frame rate of about 30 frames per second. The array may have on the order of one million addressable image sensors.

The imager 40 itself should have a global electronic shutter in which all the sensors are simultaneously exposed for light capture. Most CCD arrays are designed with a global electronic shutter. A typical CMOS array is designed with a rolling electronic shutter in which different sensors are exposed at different times. If a CMOS array is used, then it must be designed to allow a global electronic shutter.

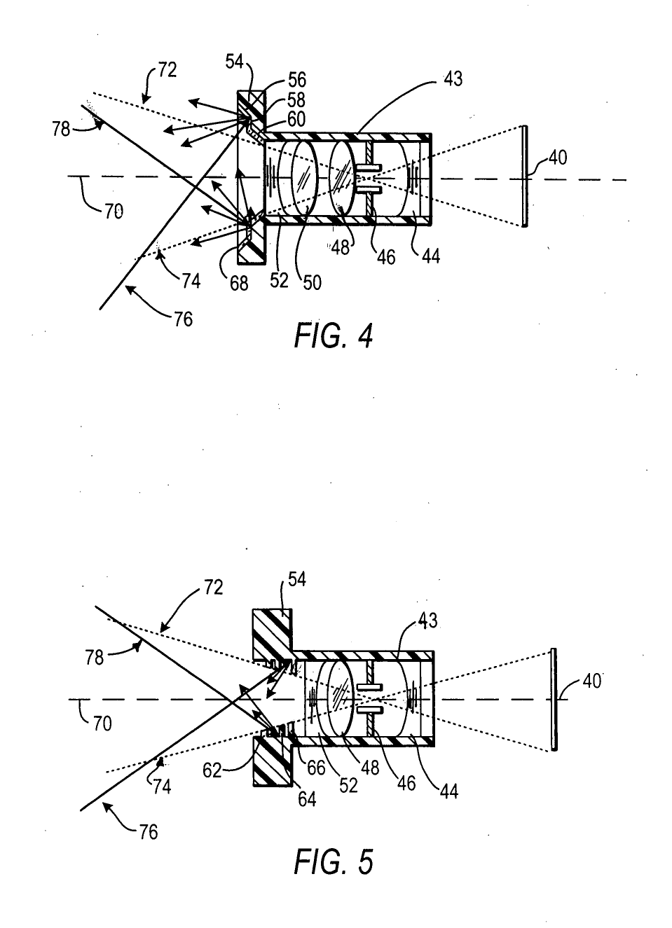

Optical assemblies for capturing light from the indicia are shown in more detail in FIGS. 4-5 and include a plurality of optical elements axially spaced away from the imager 40 along an optical axis 70. The optical elements include a first planoconcave lens 44 closest to the imager 40, an aperture stop 46, a first convex lens 48, a second convex lens 50, and a second planoconcave lens 52 furthest from the imager 40. The optical elements enable the light to be captured over the field of view indicated by the dashed lines 72, 74, which intersect in the plane of the aperture stop 46. The illustrated optical elements are merely exemplary. For example, in FIG. 5, the lens 50 has been omitted. Different optical elements are also within the scope of this invention. The holder 43 is operative for holding the optical elements, and is preferably configured as a generally cylindrical barrel.

In accordance with this invention, a baffle 54 is integrated with the holder 43, for reducing stray light directed, either directly or indirectly, to the imager 40. The baffle 54 is located at the end region of the barrel 43 furthest from the imager 40. The barrel 43 has a diameter, and the baffle 54 is annular and has a diameter greater than the diameter of the barrel.

In the embodiment of FIG. 4, the baffle 54 has a plurality of surfaces 56, 58, 60 for reflecting and scattering the stray light incident thereon away from the imager 40. Surfaces 56, 60 are inclined at different angles of inclination relative to the optical axis 70, and surface 58 is generally orthogonal to the optical axis 70. The stray light, as indicated by the rays 76, 78, that is incident on these surfaces, is reflected and/or scattered therefrom away from the imager 40, thereby resisting the formation of ghost and low contrast images.

In the embodiment of FIG. 5, the baffle 54 has a plurality of annular stepped elements 62, 64, 66 of different dimensions, i.e., diameters, as considered in a direction generally orthogonal to the optical axis 70, and the different dimensions of the stepped elements 62, 64, 66 increase in a direction along the optical axis 70 toward the imager 40. Stray light incident on the stepped elements 62, 64, 66 will be reflected, scattered and in some cases, trapped among the stepped elements 62, 64, 66.

The baffle 54 and the holder.43 may be anodized or a black or other light-absorptive coating 68 may be applied especially on the surfaces 56, 58, 60 or the stepped elements 62, 64, 66 in order to still further reduce the image degrading effects of the stray light.

The baffle 54 is integrated into the lens holder 43, thereby making for a compact design. The integral baffle 54 reduces assembly and manufacturing costs and promotes the use of the reader as a miniature component or subsystem in a non-stand-alone apparatus, or a myriad of other apparatuses, such as a telephone, a mobile computer, or the like, where space is at a premium.

It will be understood that each of the elements described above, or two or more together, also may find a useful application in other types of constructions differing from the types described above. Thus, readers having different configurations can be used.

While the invention has been illustrated and described as reducing the stray light in an imaging reader, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims:

1. A reader for electro-optically reading indicia, comprising:
a housing;
an optical assembly in the housing, for capturing light from the indicia over a field of view during the reading, the optical assembly including a solid-state imager having an array of image sensors, an optical lens spaced away from the imager along an optical axis, and a holder for holding the optical lens; and
a baffle integral with the holder, for reducing an amount of stray light directed to the imager.

2. The reader of claim 1, wherein the reader has a workstation mode of operation in which the housing is stationary during reading, and a handheld mode of operation in which the housing is held in an operator's hand during reading.

3. The reader of claim 1, wherein the imager is one of a charge coupled device and a complementary metal oxide silicon device.

4. The reader of claim 1, wherein the optical assembly includes a plurality of optical lenses arranged along the optical axis.

5. The reader of claim 1, wherein the optical assembly includes an aperture stop.

6. The reader of claim 1, wherein the holder is a generally cylindrical barrel having opposite axial end regions, and wherein the baffle is located at one of the end regions of the barrel.

7. The reader of claim 6, wherein the barrel has a diameter, and wherein the baffle is annular and has a diameter greater than the diameter of the barrel.

8. The reader of claim 1, wherein the baffle has a plurality of surfaces for reflecting and scattering the stray light incident thereon away from the imager.

9. The reader of claim 8, wherein one of the surfaces is inclined relative to the optical axis, and wherein another of the surfaces is generally orthogonal to the optical axis.

10. The reader of claim 1, wherein the baffle has a plurality of stepped elements of different dimensions as considered in a direction generally orthogonal to the optical axis, and wherein the different dimensions of the stepped elements increase in a direction along the optical axis toward the imager.

11. The reader of claim 1, and a light-absorptive coating on the baffle and the holder.

12. A reader for electro-optically reading indicia, comprising:
means for capturing light from the indicia over a field of view during the reading with a solid-state imager and an optical lens spaced away from the imager;
means for holding the optical lens in a holder; and
means for reducing an amount of stray light directed to the imager by integrating a baffle with the holder.

13. A method of electro-optically reading indicia, comprising the steps of:
capturing light from the indicia over a field of view during the reading with a solid-state imager having an array of image sensors, and by spacing an optical lens away from the imager along an optical axis;
holding the optical lens with a holder; and
reducing an amount of stray light directed to the imager by integrating a baffle with the holder.

14. The method of claim 13, wherein the capturing step is performed by a plurality of optical lenses arranged along the optical axis.

15. The method of claim 13, wherein the capturing step is performed by an aperture stop.

16. The method of claim 13, wherein the holding step is performed by a generally cylindrical barrel having opposite axial end regions, and locating the baffle at one of the end regions of the barrel

17. The method of claim 16, and configuring the barrel with a diameter, and configuring the baffle with an annular shape having a diameter greater than the diameter of the barrel.

18. The method of claim 13, wherein the reducing step is performed by forming the baffle with a plurality of surfaces for reflecting and scattering the stray light incident thereon away from the imager.

19. The method of claim 18, and inclining one of the surfaces relative to the optical axis, and positioning another of the surfaces to be generally orthogonal to the optical axis.

20. The method of claim 13, wherein the reducing step is performed by forming the baffle with a plurality of stepped elements of different dimensions as considered in a direction generally orthogonal to the optical axis, and increasing the different dimensions of the stepped elements in a direction along the optical axis toward the imager.

21. The method of claim 13, and applying a light-absorptive coating on the baffle and the holder.
